(19) United States
(12) Patent Application Publication
(10) Pub. No.: US 2021/0269071 A1
(43) Pub. Date: Sep. 2, 2021

(54) WHEEL FORCE MEASUREMENT SYSTEMS AND METHODS

(71) Applicant: Westinghouse Air Brake Technologies Corporation, Pittsburgh, PA (US)

(72) Inventor: Munishwar Ahuja, Bangalore (IN)

(21) Appl. No.: 17/185,787

(22) Filed: Feb. 25, 2021

Related U.S. Application Data
(60) Provisional application No. 62/984,112, filed on Mar. 2, 2020.

(51) Int. Cl. B61K 9/00; B61L 15/00; B60W 30/02; B61F 99/00; B60W 40/06; B60W 40/12; B60Q 9/00; G01L 27/00; G01L 1/22

(52) U.S. Cl. CPC B61K 9/00; B60W 2720/00; B60W 30/025; B61F 99/00; B61L 15/0081; B60W 40/06; B60W 40/12; B60Q 9/00; G01L 27/002; G01L 1/22; B61L 2201/00; B60W 2420/22; B60W 2530/20; B60W 2552/35; B61L 15/00

(57) ABSTRACT

A system determines a wheel contact force in a vehicle that includes a support system including a wheel and a force transmission member configured to transfer a load and/or power to, and from, the wheel to the support system. The includes a sensor connected to the force transmission member that is configured to detect strain in the force transmission member and generate signals representative of the strain and a processor configured to derive a lateral force on the wheel from the signals. A method of calibrating a wheel force measurement system for a vehicle includes measuring a lateral force on a flange of a wheel in contact with a rail or road surface, generating data with a sensor on the force transmission member, and calibrating the data based at least in part on the measured lateral force. A method of operating a vehicle includes determining a plurality of lateral forces Y on a wheel of the vehicle, summing a plurality of lateral forces Y to determine a sum of wheel lateral forces ΣY, determining a vertical force Q on the wheel, determining a lateral to vertical coefficient value defined as ΣY/Q, and controlling operation of the vehicle to maintain the lateral to vertical coefficient below a determined limit or within a determined range.

### CROSS REFERENCE TO RELATED APPLICATIONS

This application claims priority to U.S. Application 62/984,112, filed Mar. 2, 2020, the entire contents of which are incorporated herein by reference.

### BACKGROUND

### Technical Field

Embodiments of the disclosure relate to systems and methods for measuring wheel contact forces of a vehicle.

### Discussion of Art

Regulations may require that the wheel contact forces of a vehicle, such as a railway vehicle, be monitored during operation to reduce the risk of accidents, such as derailments, that may occur. The ratio of the lateral forces Y to the vertical forces Q, known as the derailment coefficient (Y/Q) for railway vehicles, may be continuously monitored during operation of the vehicle to control operation of the vehicle to reduce the risk of instability & impact on infrastructure.

Wheel contact forces may be estimated from the effects that the vertical and lateral forces have on the vehicle components and/or the route surface, e.g. rails. There are measuring systems currently in use to determine the wheel contact forces. In railway vehicles, instrumented wheelset systems use instrumentation, such as strain gauges, on the wheel web to record radial strains which are used to estimate the contact forces and determining safety assessment parameters such as the derailment coefficient. Although instrumented wheelset systems may provide continuous measurement across the length of the track and are considered the most accurate system available, they are expensive and supplied by only a few worldwide suppliers. Instrumented wheelset systems are an example of onboard systems.

Instrumented track systems, sometimes referred to as wayside systems, include instrumentation, such as strain gauges, on portions of the rails to estimate the contact forces. Instrumented track systems require instrumentation and calibration of the track for limited lengths, for example at curves. Although less expensive than instrumented wheel systems, instrumented track systems are dependent on customer approval which may be difficult to obtain as customers may not want to allow deterioration of the rail infrastructure during calibration. Instrumented track systems are also limited by the track length coverage that may be available for estimating the contact forces and determining safety assessment parameters such as the derailment coefficient.

Instrumented bearing adaptor systems are cost effective but may be a crude method for estimating the contact forces and determining safety assessment parameters such as the derailment coefficient.

It may be desirable to have a system and method that differs from those that are currently available.

### BRIEF DESCRIPTION

In accordance with one embodiment, a system for determining a wheel contact force in a vehicle may be provided. The vehicle may include a support system including a wheel and a force transmission member configured to transfer a load and/or power to, and from, the wheel to the support system. The system may include a sensor connected to the force transmission member that is configured to detect strain in the force transmission member and generate signals representative of the strain and a processor configured to derive a lateral force on the wheel from the signals.

In accordance with one embodiment, a method of calibrating a wheel force measurement system for a vehicle may be provided. The vehicle may include a support system including a wheel and a force transmission member, with the force transmission member being configured to transfer a load and/or power from the wheel to and from the support system. The method may include measuring a lateral force on a flange of a wheel in contact with a rail or road surface; generating data with a sensor on the force transmission member; and calibrating the data based at least in part on the measured lateral force.

In accordance with one embodiment, a method of operating a vehicle may include determining a plurality of lateral forces Y on a wheel of the vehicle; summing a plurality of lateral forces Y to determine a sum of wheel lateral forces ΣY; determining a vertical force Q on the wheel; determining a lateral to vertical coefficient value defined as ΣY/Q; and controlling operation of the vehicle to maintain the lateral to vertical coefficient below a determined limit or within a determined range.

### BRIEF DESCRIPTION OF THE DRAWINGS

The inventive subject matter may be understood from reading the following description of non-limiting embodiments, with reference to the attached drawings, wherein below:

FIG. 1 schematically depicts top view of a wheel force measurement system according to one embodiment;

FIG. 2 schematically depicts a bottom view of the wheel force measurement system of FIG. 1;

FIG. 3 schematically depicts a computer of the wheel force measurement system of FIG. 1;

FIG. 4 depicts a calibration system for the wheel force measurement system according to one embodiment;

FIG. 5 schematically depicts a method of calibrating a wheel force measurement system according to one embodiment;

FIG. 6 schematically depicts results of a calibration of a wheel force measurement system according to one embodiment; and

FIG. 7 schematically depicts a method of operating a railway vehicle according to one embodiment.

### DETAILED DESCRIPTION

Embodiments of the subject matter described herein relate to a system and method to measure wheel contact forces of a vehicle that provide continuous, dynamic measurement of the forces. The system may be less expensive than current systems and may not rely on a limited number of suppliers. The method may provide an accurate cost-effective alternative that may be calibrated by data, including field data, that may be obtained during testing and/or operation of the vehicle including the system.

The system and method may use strain data provided by a sensor on a component of the vehicle that transfers a load and/or power from a wheelset of the vehicle to a frame or support system of the vehicle that carries the wheelset. The data from the sensor may be provided to a computer that may be onboard the vehicle. The data may be stored in the computer. The data may also be calibrated to provide a measurement of lateral forces on the wheels of the vehicle. The data may also be used to provide a dynamic measurement of the lateral forces on the wheels.

The calibration of the data from the sensor may be done so that the results are independent of the angular position of the wheel and independent of the wheel contact position with the route surface, e.g. a rail. The calibration is also repeatable and the relationship between the strain data from the sensor and the measured lateral force is linear.

Where the vehicle is a railway vehicle, each car may include a car body, two support systems, and four to six wheelsets. To connect them, each car may include a primary suspension unit, a secondary suspension unit, anti-roll bars, yaw dampers, a traction link, and lateral dampers. Dynamic characteristics of each of the components may be modeled by three degrees of freedom or six degrees of freedom in braking, and the dynamic behavior of the vehicle is evaluated by solving these differential equations numerically.

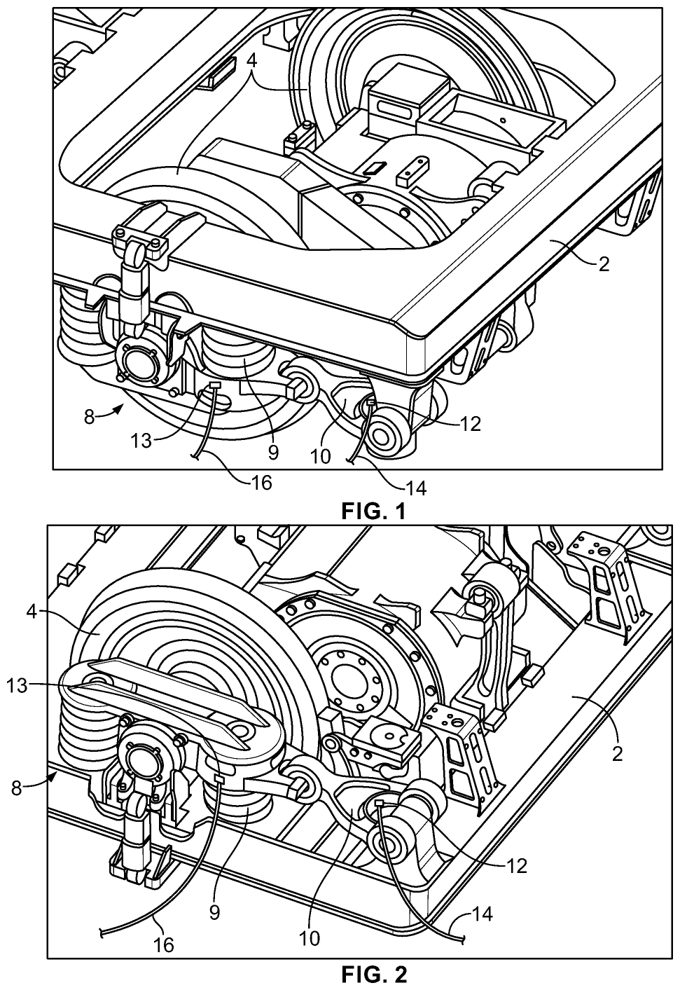

Referring to FIG. 1, a suitable vehicle may be a railway vehicle. In the illustrated embodiment the railway vehicle includes a support system 2, and in this embodiment is a railway vehicle bogie or a truck. A plurality of wheels 4 may be fixed to the support system. The wheels can engage rails 6 (FIG. 4) on which the railway vehicle may operate. The support system may carry additional components, such as traction motors, brake system components, and suspension system components. The support system may include a primary suspension 8 that carries the weight of the support system and any components attached to the support system. The primary suspension may include at least one spring element 9, for example a coil spring. The support system may include at least one force transmission member 10 that is that can transfer a load and/or power from the wheelset to the support system. According to one embodiment the force transmission member may be a traction link. The traction link can transmit power from a wheelset journal/axle box of the support system to the support system frame/body of the railway vehicle. The traction link may be in the form of a bar attached at one end to the wheelset journal/axle box of support system to the support system frame/body of the railway vehicle. Both ends may be fitted with rubber damping to provide flexibility and reduce transmission of vibration.

Referring to FIGS. 1 and 2, at least one sensor 12 may be provided to a U-shaped portion of the traction link to sense forces applied to the traction link. A suitable sensor may be a strain gauge. The sensor, or gauge, may detect strain in the traction link. The location of the strain gauge may be chosen to provide minimum cross coupling between the lateral force to the longitudinal or vertical force. The strain detected by the strain gauge may be representative of lateral forces applied to the traction link. The lateral forces applied to the traction link may be representative of the wheel contact forces, including the lateral force on the wheels of the support system in contact with the rails.

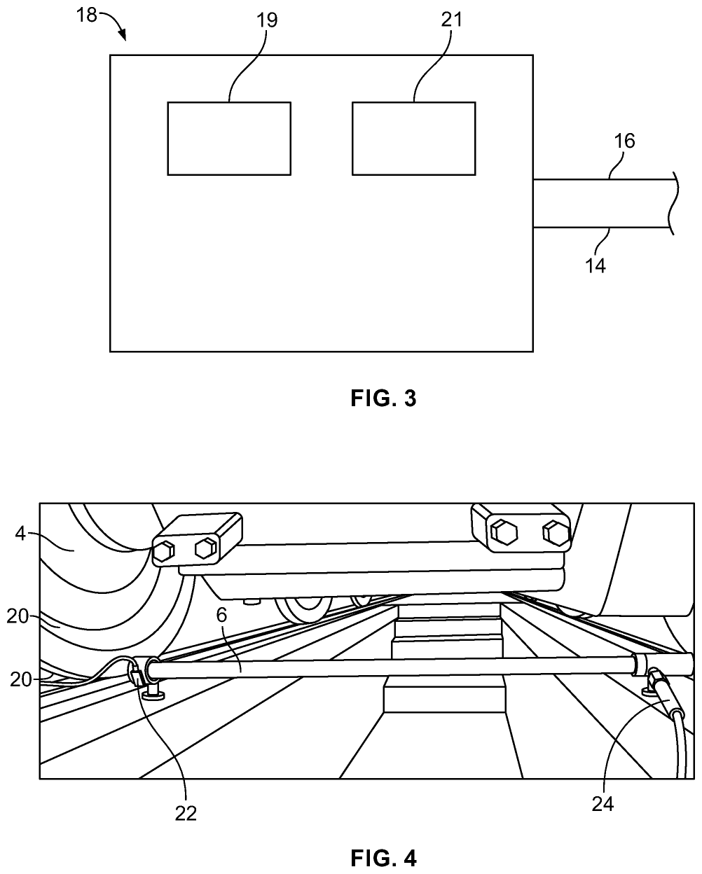

Referring to FIGS. 1-3, the strain gauge may communicate with a controller or a computer 18. This may be done using electrical leads 14 such as wiring. The wiring sends signals generated by the strain gauge to the computer. In other embodiments, the signals may be transmitted wirelessly. The controller or computer may include a processor 19 that can execute programs stored in a memory 21 of the controller or computer to determine the lateral and vertical forces from the signals from the strain gauge. Another sensor 13 in the primary suspension may determine displacement of the coil spring. Displacement may be representative of the vertical forces of the wheel contact forces. The signals from such a sensor may be communicated to the computer. The signals from the sensors may be stored in memory.

The signals from the strain gauge and the spring displacement sensor may be calibrated to determine the lateral and vertical wheel contact forces. Referring to FIG. 4 a system for calibrating the data from the signals from the traction link strain gauge and the spring displacement sensor may be provided. A hydraulic actuator 24 may provide a lateral force to the flange of the wheel that may be measured by a load cell 22. The lateral force detected by the load cell may be sent to the controller or computer along with signals generated by strain gauges 20 of an instrumented wheel set force measurement system. Calibration is done at multiple locations on the wheelset, e.g., 0, 60, 120, 180, 240 degrees around the circumference, to ensure calibration is independent of the wheelset angular position and remains linear. The data from the signals from the strain gauges is calibrated with the lateral force applied by the hydraulic actuator and detected by the load cell. The vertical force applied to the wheel may be determined by the spring displacement sensor that measures the displacement of the coil spring of the primary suspension. Calibration may be done under static condition where friction between wheel-rail interface is significant and to minimize that component the wheel is slightly lifted from ground so that entire force is being reacted by the traction link. The lateral force on the wheel may be determined by multiplying the signal from the strain gauge on the traction link by a calibration factor.

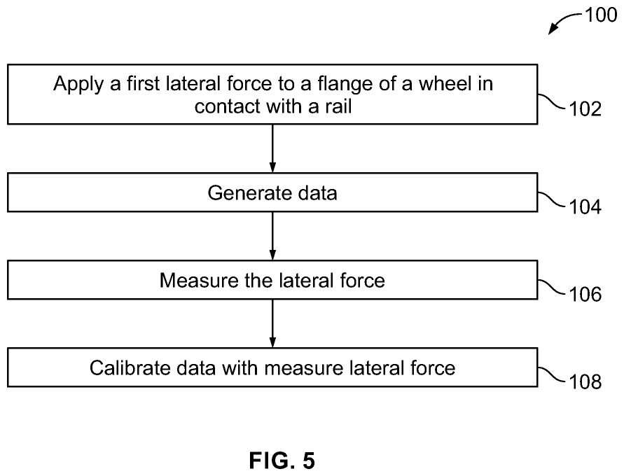

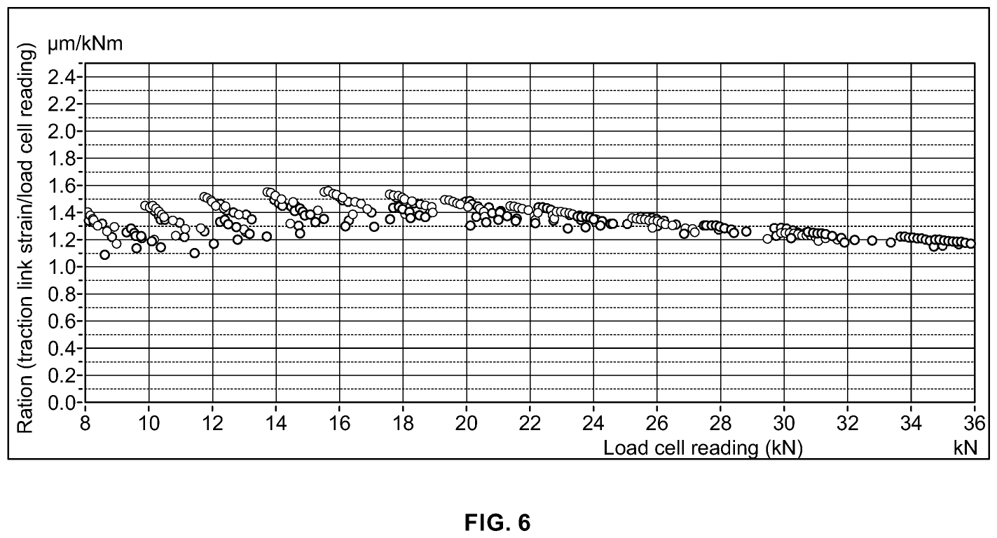

Referring to FIG. 5, a method 100 of calibrating a wheel force measurement system may begin at step 102 by applying a first lateral force to a wheel in contact with a route surface such as a rail, for example by the hydraulic actuator. In step 102 data is generated by a sensor provided on a force transmission member, for example the sensor on the traction link. The method continues in step 104 where the first lateral force is measured, for example by the load cell. In step 106, the data from the traction link strain gauge, the load cell, and the strain gauges of the wheelset are calibrated. It should be appreciated that the method may include additional applications of lateral force, reception of traction link strain gauge data, and calibrations. Referring to FIG. 6, a calibration of strain gauge data with measured applied lateral forces according to one embodiment is shown.

The vehicle may be monitored during operation to provide for safe operation. Regulations may define assessment quantities for running behavior that may be measured directly, derived from other measurements, or generated by use of simulation. The assessment quantities are used to assess the interaction between the vehicle and the route surface, for example the rail or track. The regulations may set limit values for the various assessment quantities that should not be exceeded to provide safe operation of the vehicle. For example, the UIC 518 and EN 14363 regulations define a limit value for the derailment coefficient (Y/Q).

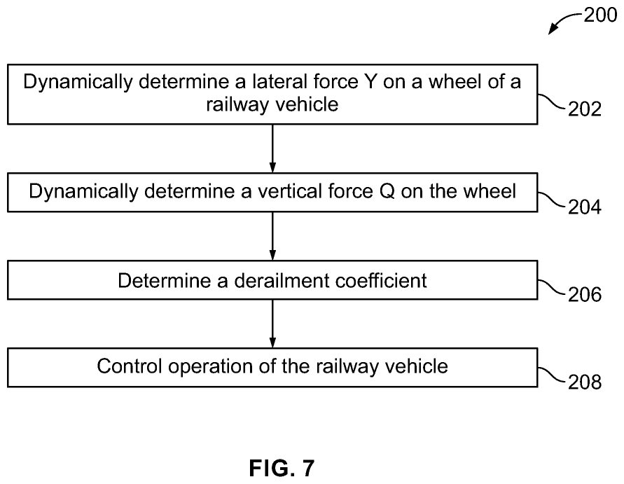

Referring to FIG. 7, a method 200 of operating a vehicle begins in step 202 by dynamically determining a lateral force Y on a wheel of the vehicle based on data from a sensor provided on a force transmission member, for example a traction link, of a support system of the vehicle. As noted above, the lateral force may be dynamically determined from sensor data by using the calibration method as stated earlier. The method continues in step 204 by determining a vertical force Q on the wheel and in step 206 by determining a lateral to vertical coefficient value defined as Y/Q. The vertical force Q may be determined by, for example, measuring a displacement of a spring of a suspension of the support system or by a pressure transducer in an axle box of the support system. The method concludes in step 208 by controlling operation of the vehicle to maintain the coefficient below a determined limit. The method may be implemented by executing a program provided in a computer, for example the controller or the computer.

The forces measured during operation of the vehicle, including the lateral forces Y and the vertical forces Q, may be dependent on a quality of the surface route, for example the track or rails. Qualities of the track including, for example, unevenness, alignment, gage narrowing or widening, and/or twist, may be measured it is also possible to make an assessment of relative track quality using the measured forces, including lateral forces Y, the sum of lateral forces ΣY, vertical forces Q, and the derailment coefficient Y/Q. The assessment may allow comparison of tracks or sections of track within a network and may be used to predict and provide notice that track measurement or repair on a particular section should be performed when a limiting value of at least one of the lateral force, the sum of the lateral force, a vertical force, or the derailment coefficient is exceeded. According to one embodiment a method of assessing the quality of a track may include dynamically determining a lateral force Y on a wheel of the railway vehicle based on data from a sensor provided on a force transmission member of a support system of the railway vehicle; determining a sum of wheel lateral forces ΣY; determining a vertical force Q on the wheel; determining a derailment coefficient defined as Y/Q; and generating a notification to measure or repair at least a portion of the track when at least one of the lateral force, the sum of wheel lateral forces, the vertical force, or the derailment coefficient exceeds a limiting value.

In one embodiment, a system for determining wheel contact forces in a vehicle is provided. The vehicle may include a support system including a wheel and a force transmission member that can transfer a load and/or power from the wheel to the support system. The system may include a sensor connected to the force transmission member that can detect strain in the force transmission member and generate signals representative of the strain and a processor that can derive a lateral force on the wheel from the signals.

Optionally, the force transmission member may be a traction link. Optionally the traction link may include a U-shaped portion and the sensor may be provided on the U-shaped portion of the traction link.

Optionally, the vehicle may be a railway vehicle and the sensor may be a strain gauge.

Optionally, the processor may determine a ratio of the lateral force to a vertical force. Optionally, the processor may control operation of the vehicle to maintain the ratio within a determined range or below a determined limit.

Optionally, a vehicle may include the system for determining wheel contact forces and may include a controller coupled with the processor and configured to operate the vehicle at least in part on the determined ratio. Optionally, the controller may be configured to operate the vehicle based at least in part on a characteristic of one or more of a wheel and a road surface or a track surface.

A method of calibrating a wheel force measurement system for a vehicle may be provided. The vehicle may include a support system including a wheel and a force transmission member. The force transmission member may be configured to transfer a load and/or power from the wheel to and from the support system. The method may include measuring a lateral force on a flange of a wheel in contact with a rail or road surface and generating data with a sensor on the force transmission member. The method may include calibrating the data based at least in part on the measured lateral force.

Optionally, measuring the lateral force may include measuring strain in the wheel at a plurality of angular positions. Optionally, the measurement of wheel contact force may be independent of wheel angular position, and independent of wheel contact position.

Optionally, the sensor may be positioned to provide minimum coupling between a lateral force applied to the force transmission member and a longitudinal force or vertical force applied to the force transmission member. Optionally, the processor may be configured such that the data indicates a lateral strain of the force transmission member and the strain may be linearly related to the measured lateral force.

A method of operating a vehicle may include determining a plurality of lateral force Y on a wheel of the vehicle; summing a plurality of lateral forces to determine a sum of wheel lateral forces Y. The method may include determining a vertical force Q on the wheel and determining a lateral to vertical coefficient value defined as Y/Q. The method may include controlling operation of the vehicle to maintain the lateral to vertical coefficient below a determined limit or within a determined range.

Optionally, determining the lateral force may include receiving data from a force transmission member sensor. Optionally, the method may include determining the plurality of lateral force by multiplying strain data by a determined calibration factor.

Optionally, the vehicle is a railway vehicle operating on rails and the method may further include determining from one or more of the lateral forces, the sum of wheel lateral forces, the vertical force, or the lateral to vertical coefficient value a quality of the rails including one or more of unevenness, alignment, gage narrowing or widening, or twist.

Optionally, the method may further include generating a notification when the lateral to vertical coefficient is one or more of above the determined limit or out of the determined range. Optionally, the notification may include a notification to measure at least a portion of the rails. Optionally, the notification may include a notification to repair at least a portion of the rails.

The example of a railway vehicle is illustrative. In one embodiment, the vehicle is a on-road vehicle, such as an automobile or a semi-tractor truck. In other embodiments, the vehicle is a mining vehicle or industrial vehicle. Accordingly, the wheels referenced are appropriate for the application. A railway vehicle has steel wheels and runs on steel tracks, while a on-road truck has rubber wheels and runs on asphalt or concrete roads. Where rubber is used in place of steel, the elastomeric give of the wheel may be accounted for in the calculations. Where the roadway surface condition varies, such as gravel or dirt compared to asphalt, or snow and rain compared to dry surfaces, this difference may be accounted for in calculations. Where a railway vehicle may suffer from a derailment, an on-road vehicle may suffer from lane drift, tire or wheel damage, or departure from the roadway.

As used herein, the terms “processor” and “computer,” and related terms, e.g., “processing device,” “computing device,” and “controller” may be not limited to just those integrated circuits referred to in the art as a computer, but refer to a microcontroller, a microcomputer, a programmable logic controller (PLC), field programmable gate array, and application specific integrated circuit, and other programmable circuits. Suitable memory may include, for example, a computer-readable medium. A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. As such, the term includes tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A system for determining a wheel contact force in a vehicle, the vehicle comprising a support system including a wheel and a force transmission member configured to transfer a load and/or power to, and from, the wheel to the support system, the system comprising:
a sensor connected to the force transmission member that is configured to detect strain in the force transmission member and generate signals representative of the strain; and
a processor configured to derive a lateral force on the wheel from the signals.

2. The system of claim 1, wherein the force transmission member is a traction link.

3. The system of claim 2, wherein the traction link comprises a U-shaped portion, and the sensor is disposed on the U-shaped portion of the traction link.

4. The system of claim 1, wherein the vehicle is a railway vehicle and the sensor is a strain gauge.

5. The system of claim 1, wherein the processor is configured to determine a ratio of the lateral force to a vertical force.

6. The system of claim 5, wherein the processor is further configured to control operation of the vehicle to maintain the ratio below a determined limit or within a determined range.

7. A vehicle comprising the system of claim 6, wherein the vehicle comprises a controller coupled with the processor, and the controller is configured to operate the vehicle based at least in part on the determined ratio.

8. The vehicle of claim 7, wherein the controller is further configured to operate the vehicle based at least in part on a characteristic of one or more of a wheel, and a road surface or a track surface.

9. A method of calibrating a wheel force measurement system for a vehicle comprising a support system including a wheel and a force transmission member, with the force transmission member being configured to transfer a load and/or power from the wheel to and from the support system, the method comprising:
measuring a lateral force on a flange of a wheel in contact with a rail or road surface;
generating data with a sensor on the force transmission member; and
calibrating the data based at least in part on the measured lateral force.

10. The method of claim 9, wherein measuring the lateral force comprises measuring strain in the wheel at a plurality of angular positions.

11. The method of claim 9, wherein the measurement of wheel contact force is calculated independent of wheel angular position, and independent of wheel contact position.

12. The method of claim 9, wherein the sensor is positioned to provide minimum coupling between a lateral force applied to the force transmission member and a longitudinal force or vertical force applied to the force transmission member.

13. The method of claim 9, wherein the processor is configured such that the data indicates a lateral strain of the force transmission member and the strain is linearly related to the measured lateral force.

14. A method of operating a vehicle, comprising:
determining a plurality of lateral forces Y on a wheel of the vehicle;
summing a plurality of lateral forces Y to determine a sum of wheel lateral forces ΣY;
determining a vertical force Q on the wheel;
determining a lateral to vertical coefficient value defined as ΣY/Q; and
controlling operation of the vehicle to maintain the lateral to vertical coefficient below a determined limit or within a determined range.

15. The method of claim 14, wherein determining the lateral force comprises receiving data from a force transmission member sensor.

16. The method of claim 14, further comprising determining the plurality of lateral force by multiplying strain data by a determined calibration factor.

17. The method of claim 14, wherein the vehicle is a railway vehicle operating on rails, the method further comprising determining from one or more of the lateral forces, the sum of wheel lateral forces, the vertical force, or the lateral to vertical coefficient value a quality of the rails including one or more of unevenness, alignment, gage narrowing or widening, or twist.

18. The method of claim 14, further comprising generating a notification when the lateral to vertical coefficient is one or more of above the determined limit or out of the determined range.

19. The method of claim 18, wherein the notification comprises a notification to measure at least a portion of the rails.

20. The method of claim 18, wherein the notification comprises a notification to repair at least a portion of the rails.
